(19) United States
(12) Patent Application Publication
(10) Pub. No.: US 2004/0061308 A1
(43) Pub. Date: Apr. 1, 2004

(54) Extendable trailer with controlled release mechanism

(76) Inventors: Paul J. McCarron, Bangor, PA (US); Richard J. Sheridan, Bangor, PA (US)

Correspondence Address: Kenneth P. Glynn, Esq., Glynn & Associates, P.C., 24 Mine Street, Flemington, NJ, 08822, US

(21) Appl. No.: 10/213,689

(22) Filed: Aug. 7, 2002

(51) Int. Cl. B60D 1/00

(52) U.S. Cl. 280/478.1

(57) ABSTRACT

The present invention is an extendable trailer with an extending unit having a controlled release mechanism to be extended to eliminate or reduce the need to back a vehicle to unload. This feature is useful and sometimes even necessary when unloading or loading at a dock or a building, a narrow opening, or on a slope, e.g. a shoreline for loading or offloading a boat. The trailer includes: (a) a trailer support frame having a front end, a back end, two side supports, and at least two wheels; (b) an outer member permanently attached to the front end of the trailer support; (c) an inner member located within the outer member, the inner member being movable from front toward back and vice versa within the outer member, the inner member having a length significantly greater than the predetermined length of the outer member; (d) a stop mechanism connected to at least one of the outer member and the inner member to prevent removal of the inner member from the outer member; and, (e) an advance-retract mechanism connected to the inner member and at least one of the outer member and the trailer support frame, the advance-retract mechanism adapted to securely move the inner member backward and forward relative to the outer member. In some preferred embodiments, the trailer may include a boat cradle, i.e. a trailer that includes support members specifically adapted to support a boat.

### BACKGROUND OF THE INVENTION

1. Field of the Invention

The present invention relates to trailers and, more specifically, to towing trailers which are removably hitched to a back bumper hitch device of a motorized vehicle. Such trailers include boat trailers, horse trailers, camper trailers (campers), enclosed and open bed trailers, and special purpose trailers such as portable generators, small cement mixers, log splitters, etc. More specifically, the present invention is directed to creating a trailer which can be moved away from a vehicle without being disconnected, but in a safe and controlled manner.

2. Information Disclosure Statement

U.S. Pat. No. 4,407,519 describes a trailer tongue extender that is attached to the tongue of a boat trailer as a first step in launching the boat, allowing the vehicle that is backing the trailer into the water to keep back from the uncertain ground near the water's edge. The extender latches into a receptacle that is permanently installed on the trailer tongue allowing the attachment or removal of the extender in three steps without the use of tools, bolts, or pins.

U.S. Pat. No. 5,108,121 describes a device for attachment to a boat trailer including an extension arm for facilitating the launching of a boat into the water, and loading of the boat onto the trailer from the water. The extension arm consists of a first elongate member to be attached to, and to extend horizontally from, a side of a trailer, and a second elongate member which is longitudinally extendable and is coupled at one end to the first elongate member so as to extend generally perpendicularly to the first member. The second member has a guide member at its second end for guiding the boat during launching/loading operations. Preferably, the coupling between the first and second members allows a selection of angular positions of said second member about a horizontal axis defined by the first member.

U.S. Pat. No. 5,114,168 describes an improved boat trailer for enabling a single operator to load and unload marine craft. The boat trailer includes an extendable tongue allowing it to be submersed by a conventional motor vehicle. The trailer includes laterally separated guide posts adjacent the rear of the trailer and a forward sliding mooring hook assembly. When the trailer is backed into the water, the boat is free to float off the trailer as a slide member supporting the front end of the boat slides upwardly along a slide channel. When loading the boat onto the trailer, the boat is moved into position over the trailer and the fore and of the boat is fastened to the slide member. As the boat is withdrawn from the water, the boat settles onto the trailer in registry with supporting members being guided by the freely moving slide member and the laterally separated guide posts.

U.S. Pat. No. 5,228,713 describes a boat trailer adapted to be towed behind a vehicle, comprising a lower, boat-carrying frame and an upper, boat-guiding frame pivotally associated with the lower frame and provided with flotation devices. During launch, or recovery, of a boat into or out of a body of water, the upper frame floats pivoted from the lower frame to maintain boat restraining side rails in operable position during launch and recovery of the boat. Quickly attached and detached foot platforms are provided which allow the operator to walk along the upper frame to manually tend to the boat as necessary. A telescopingly extendible tongue is provided, to prevent the necessity of backing the towing vehicle into the water at gradually sloped launching sites.

U.S. Pat. No. 5,520,494 describes an extendable boat trailer comprised of a first length of square tubing secured to a trailer support frame. The first length of square tubing has two apertures therethrough inwardly of an open end portion. A brake light receptacle is secured to an upper portion of the first length of square tubing. The brake light receptacle has a length of wire coupling with a tow vehicle and a trailer's brake lights. A second length of square tubing has three apertures formed therethrough. The second length has a butt plate secured thereto. The second length is adapted to be received within the open end portion of the first length of square tubing with the two apertures thereof of selectively aligning with the three apertures of the third length for securement therewith by a fastening device. A trailer hitch is secured to the second length of square tubing. The trailer hitch is adapted for securement to the tow vehicle.

Notwithstanding the prior art,, the present invention is neither taught nor rendered obvious thereby.

### SUMMARY OF THE INVENTION

The present invention is an extendable trailer with a controlled release mechanism to be extended to eliminate or reduce the need to back a vehicle to unload. In other words, the purpose of the invention is to enable a parked vehicle and trailer to have the trailer moved without further movement of the vehicle. This feature is useful and sometimes even necessary when unloading or loading at a dock or to or from a train, a building, a narrow opening, or on a slope, e.g. a shoreline for loading or offloading a boat.

The present invention trailer includes: (a) a trailer support frame having a front end, a back end, two side supports, and at least two wheels, the back end having brake lights thereon, the trailer support frame adapted for supporting a load thereon; (b) an outer member permanently attached to the front end of the trailer support, the outer member having a predetermined length; (c) an inner member located within the outer member, the inner member being movable from front toward back and vice versa within the outer member, the inner member having a predetermined length greater than the predetermined length of the outer member; (d) stop means connected to at least one of the outer member and the inner member and adapted to prevent removal of the inner member from the outer member; and, (e) advance-retract means connected to the inner member and at least one of the outer member and the trailer support frame, the advance-retract means adapted to securely move the inner member backward and forward relative to the outer member. In some preferred embodiments, the trailer may include a boat cradle, i.e. a trailer that includes support members specifically adapted to support a boat.

The inner member has a front end and a back end, and the front end includes a trailer hitch. The stop means is located at the back end and may be included at the front end, although a trailer hitch itself may act as a front stop.

The controlled release mechanism of the present invention is an advance-retract mechanism and may be selected from a winch mechanism, a rack and pinion, a worm gear, lockable pegs and orifices, or equivalent mechanism, and any of those may be manual or motorized.

The extending unit of the present invention may be made of metal, or other strong material, even wood or heavy duty plastic would be possible. However, metal is the material of choice, preferably treated for outdoor exposure, such as galvanized metal or aluminum. The choice of cross-sectional design is limitless, as long as the inner member is movable and reasonably well secured within the outer member. Length and size may vary depending upon the size and weight of the load and the length of extension desired.

### BRIEF DESCRIPTION OF THE DRAWINGS

The present invention should be more fully understood when the specification herein is taken in conjunction with the drawings appended hereto wherein:

FIGS. 1 and 2 show partial side views of one embodiment of the present invention extendable trailer with controlled release mechanism in its extended and retracted positions, respectively;

FIG. 3 shows a detailed partial side cut view of the present invention device shown in FIGS. 1 and 2 and FIG. 4 shows a top partial cut view thereof;

FIG. 5 shows a side view of a present invention device similar to that shown in the previous Figures in actual use;

FIG. 6 shows a side partial cut view of an alternative present invention device with a motorized rack and pinion control mechanism;

FIG. 7 shows another alternative embodiment present invention device with a motorized worm gear, in a partially cut side view;

FIG. 8 shows a partially cut side view of a manually operated winch-containing present invention device and FIG. 9 shows a rear view thereof; and,

FIG. 10 shows a side view of a manually operated rack and pinion-based present invention device.

### DETAILED DESCRIPTION OF THE PRESENT INVENTION

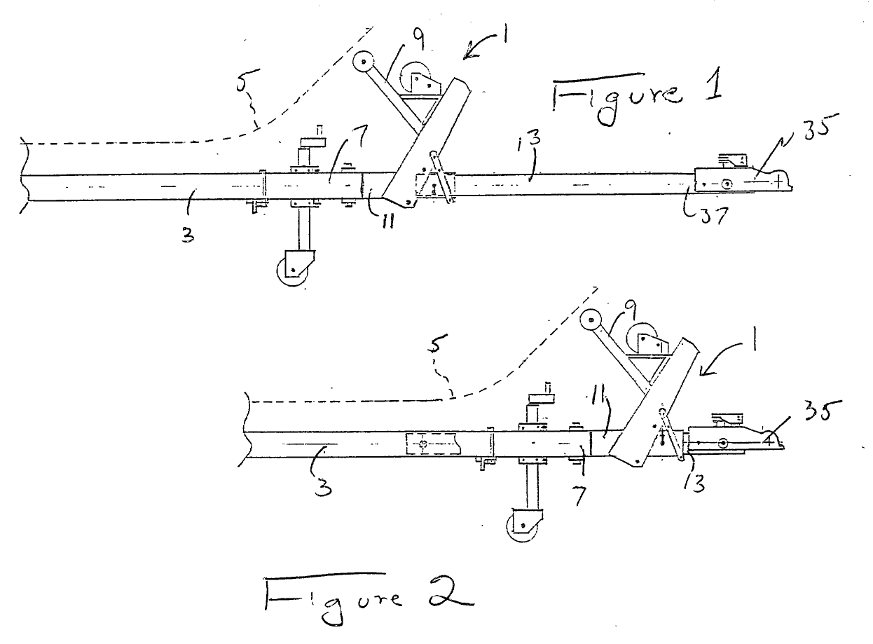

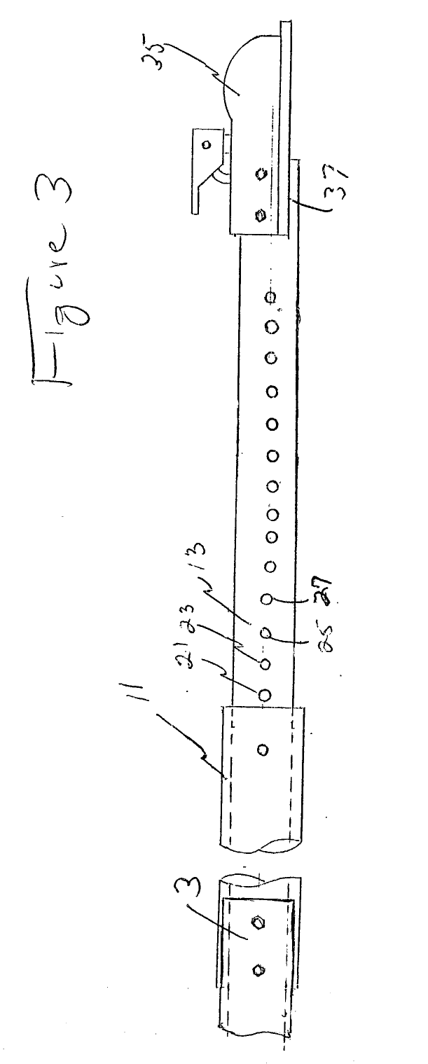

FIGS. 1 and 2 show partial side views of one embodiment of the present invention extendable trailer with controlled release mechanism in its extended and retracted positions, respectively. All elements shown in these FIGS. 1 and 2, as well as in subsequent Figures for the same device are identically numbered.

In FIGS. 1 and 2, trailer 1 includes a trailer support frame 3 which has a front end 7 and a back end (not shown). In this embodiment, there is a cradle and winch 9 adapted to receive, mount and release a boat, such as boat 5. While a boat cradle is shown in this embodiment, it could be a flatbed, a fenced flatbed, a horse trailer frame or any other purpose trailer frame. There is an outer member 11 of an extension device which is a critical feature of the present invention. It contains an inner member 13 which is movable, front to back and back to front, within said outer member 11. As can be seen from the drawings, and as described above, the inner member is significantly longer than the outer member and is preferably two to ten times its length, so as to enable maximum extendibility from a minimal trailer length in a retracted position and so as to provide for an external rear stop on the inner member.

As shown more clearly in FIGS. 3 and 4, outer member 11 is permanently and fixedly connected to trailer support frame 3, which includes side supports 3a and 3b and a plurality of cross members, some of which are shown. Inner member 13 moves forward and backward relative to outer member 11. Locking orifices 21, 23, 25, 27 and others shown on the side of inner member 13 are used to secure inner member 13 in any one of at least ten different secured positions by use of a securing bolt such as bolt 31 shown in FIG. 4. The total number of securing orifices is a matter of choice. Minimally, a front position, a middle position and a rear position orifice would be preferred. There is a conventional trailer hitch 35 connected to front end 37 of inner member 13. Any type of trailer hitch may be used. A user could simply remove the bolt 31 and manually roll the trailer back away from hitch 35, reinsert and secure the bolt and load, unload or store as desired.

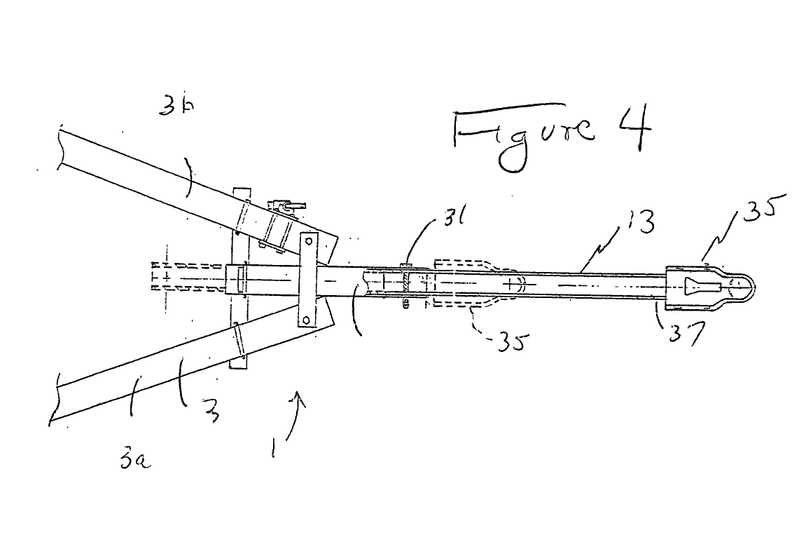

FIG. 5 shows a side view of the device shown in the previous Figure in actual use. As shown in FIG. 5, a similar trailer 61, but one designed to carry a load such as lumber 41, is connected to pick up truck 51. It has a hitch 35, which is the same as that shown above. It has an outer member 11 and an inner member 13 which functions in a fashion identically to that which is described above. Trailer 61 has a main support frame 63 and leaf springs 53 attached to its underside. It includes at least two wheels, such as wheel 43, as well as a set of taillights such as taillight 45 connected to back end 47 of trailer 61.

While the above described FIGS. 1 through 5 rely upon sequential orifices and insertable bolts with nuts or insertable rods for advance-retract control, alternative means may be employed which permit stoppage of advancement or retraction of the inner member, relative to the outer member at any point along the path. Thus, infinite stop possibility advance-retract means may be employed in place of the orifice and bolt system described. These alternatives are preferred because they permit concise positioning of the inner and outer members relative to one another. For example, with infinite stop possibility embodiments, a vehicle towing a present invention trailer, may back up to a loading dock and stop a couple of feet away from the loading dock and then retract the trailer away from the vehicle to stop and secure the back edge of the trailer exactly against the loading dock.

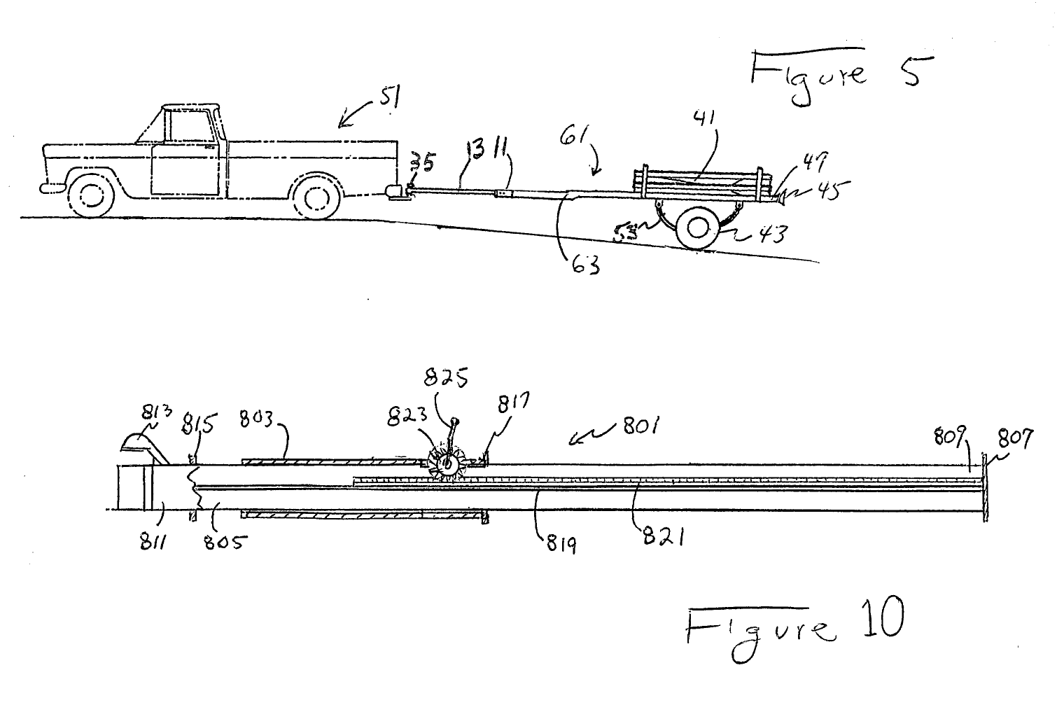

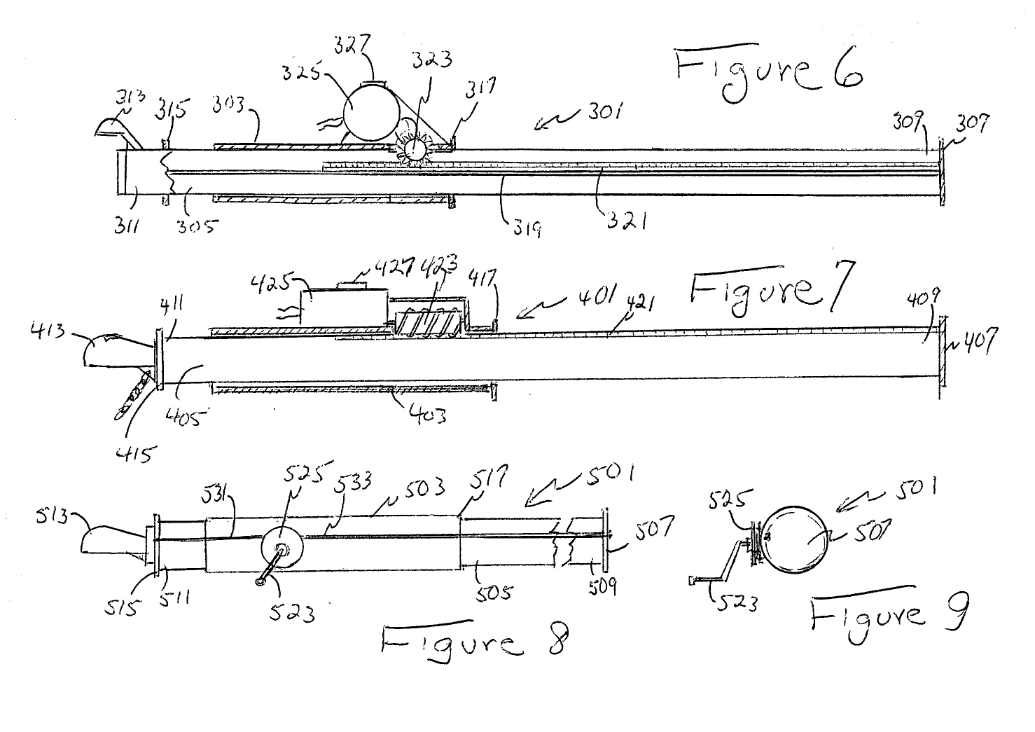

FIG. 6 shows a side partial cut view of an alternative present invention device with a motorized rack and pinion control mechanism. Unit 301 includes a short outer member 303 of a predetermined length, for example, 2.5 feet. Movable therein is inner member 305, having a predetermined length significantly greater than the predetermined length of outer member 303, for example, 10 feet. In this embodiment, outer member 303 is rectangular and inner member 305 is an I-beam on its side with its main plate being elongated plate 319 (horizontal position). A top elongated plate 319 is a rack and pinion arrangement 321 and 323. The linear gear 321 is welded to elongated plate 319 and the circular gear 323 is connected to electric motor 325. Motor 325 is connected to a power source (not shown). Motor 325 includes controls 327, which enable a user to rotate circular gear 323 clockwise or counterclockwise to move inner member 305 forward or backward. Inner member 305 includes a stop 307 at its back end 309 and a stop 315 at its front end 311, to prevent movement of inner member 305 beyond a desired range or completely out of outer member 303. Also located on front end 311 of inner member 305 is a trailer hitch socket 313 for attachment to a hitch ball which would be attached to a motorized vehicle such as a truck, pick-up truck, SUV, or the like.

FIG. 7 shows another alternative embodiment present invention device with a motorized worm gear, in a partially cut side view. Unit 401 includes a short outer member 403 of a predetermined length, e.g., about 3 feet. Movable therein is inner member 405, having a predetermined length significantly greater than the predetermined length of outer member 403, for example, 9 feet. In this embodiment, outer member 403 is rectangular and inner member 405 is a hollow rectangular member. Atop inner member 405 is a rack of linear gears 421. The worm gear 423 is connected to electric motor 425. Motor 425 is connected to a power source (not shown). Motor 425 includes controls 427, which enable a user to rotate worm gear 423 clockwise or counterclockwise to move inner member 405 forward or backward. Inner member 405 includes a stop 407 at its back end 409 and a stop 415 at its front end 411, to prevent movement of inner member 405 beyond a desired range or completely out of outer member 403. Also located on front end 411 of inner member 405 is a trailer hitch socket 413 and a safety chain, as shown, for attachment to a motorized vehicle such as a truck, pick-up truck, SUV, or the like.

FIG. 8 shows a partially cut side view of a manually operated winch-containing present invention device and FIG. 9 shows a rear view thereof. FIGS. 8 and 9 show a side partial view of a back end view of an alternative embodiment present invention unit 501. It includes an outer member 503, which, in this case, is a hollow tubular member. Inner member 505 is also a hollow tubular member and it is slidably mounted within outer member 503. There is a stop 507 and a stop 515 at back end 509 and front end 511, respectively, of inner member 505. For example, stop 507, when it contacted outer member end 517, would prevent further forward movement of inner member 505 relative to outer member 503. Locking winch 525 was hand cranked with hand crank 523 operates to simultaneously pull in wire 531 and release wire 533, or vice versa, to move the inner member 505 backward and forward. Winch 525 has two shafts so that when it is cranked, one wire will wind in and the other will unwind simultaneously. Appropriate locking mechanisms are included to secure the winch in any desired position.

FIG. 10 shows a side view of a manually operated rack and pinion-based present invention device. Unit 801 includes a short outer member 803 of a predetermined length. Movable therein is inner member 805, having a predetermined length significantly greater than the predetermined length of outer member 803. In this embodiment, outer member 803 is rectangular and inner member 805 is an I-beam on its side with its main plate being elongated plate 819 (horizontal position). Atop elongated plate 819 is a rack and pinion arrangement 821 and 823. The linear gear 821 is welded to elongated plate 819 and the circular gear 823 is connected to a hand operated crank 825. This enables a user to crank gear 823 clockwise or counterclockwise to move inner member 805 forward or backward. Inner member 805 includes a stop 807 at its back end 809 and a stop 815 at its front end 811, to prevent undesired movement of inner member 805. Also located on front end 811 of inner member 805 is a trailer hitch socket 813 for attachment to a vehicle.

Obviously, numerous modifications and variations of the present invention are possible in light of the above teachings. It is therefore understood that within the scope of the appended claims, the invention may be practiced otherwise than as specifically described herein.

What is claimed is:

1. An extendable trailer with an extending unit having a controlled release mechanism to be extended to eliminate or reduce the need to back a vehicle to unload it, which comprises:
(a) a trailer support frame having a front end, a back end, two side supports, and at least two wheels, the back end having brake lights thereon, the trailer support frame adapted for supporting a load thereon;
(b) an outer member permanently attached to said front end of said trailer support, said outer member having a predetermined length;
(c) an inner member located within said outer member, said inner member being movable from front toward back and vice versa within said outer member, said inner member having a predetermined length greater than said predetermined length of said outer member;
(d) stop means connected to at least one of said outer member and said inner member and adapted to prevent removal of said inner member from said outer member; and,
(e) advance-retract means connected to said inner member and at least one-of said outer member and said trailer support frame, said advance-retract means adapted to securely move said inner member backward and forward relative to said outer member.

2. An extendable trailer with an extending unit having a controlled release mechanism of claim 1 wherein said inner member has a front end and a back end, and said front end includes a trailer hitch, and said stop means is located at said back end.

3. An extendable trailer with an extending unit having a controlled release mechanism of claim 1 wherein said advance-retract means is a winch mechanism.

4. An extendable trailer with an extending unit having a controlled release mechanism of claim 3 wherein said winch mechanism is a hand operated winch mechanism.

5. An extendable trailer with an extending unit having a controlled release mechanism of claim 3 wherein said winch mechanism is a motorized winch mechanism.

6. An extendable trailer with an extending unit having a controlled release of claim 1 wherein said advance-retract means is a rack and pinion.

7. An extendable trailer with an extending unit having a controlled release of claim 6 wherein said rack and pinion is a hand operated rack and pinion.

8. An extendable trailer with an extending unit having a controlled release mechanism of claim 6 wherein said rack and pinion is a motorized rack and pinion.

9. An extendable trailer with an extending unit having a controlled release mechanism of claim 1 wherein said advance-retract means is a worm gear.

10. An extendable trailer with an extending unit having a controlled release of claim 9 wherein said worm gear is a hand operated worm gear.

11. An extendable trailer with an extending unit having a controlled release mechanism of claim 9 wherein said worm gear is a motorized worm gear.

12. An extendable trailer with an extending unit having a controlled release mechanism to be extended to eliminate or reduce the need to back a vehicle to unload it, which comprises:
(a) a trailer support frame having a front end, a back end, two side supports, and at least two wheels, the back end having brake lights thereon, the trailer support frame adapted for supporting a load thereon;
(b) an outer member permanently attached to said front end of said trailer support, said outer member having a predetermined length;
(c) an inner member located within said outer member, said inner member being movable from front toward back and vice versa within said outer member, said inner member having a front end and a back end, and having a predetermined length greater than said predetermined length of said outer member;
(d) a trailer hitch socket connects to said front end of said inner member;
(e) stop means connected to at least one of said outer member and said inner member and adapted to prevent removal of said inner member from said outer member; and,
(f) advance-retract means connected to said inner member and at least one of said outer member and said trailer support frame, said advance-retract means adapted to securely move said inner member backward and forward relative to said outer member; and,
(g) a boat cradle mounted atop said trailer support frame.

13. An extendable trailer with an extending unit having a controlled release mechanism of claim 12 wherein said advance-retract means is a winch mechanism.

14. An extendable trailer with an extending unit having a controlled release mechanism of claim 13 wherein said winch mechanism is a hand operated winch mechanism.

15. An extendable trailer with an extending unit having a controlled release mechanism of claim 13 wherein said winch mechanism is a motorized winch mechanism.

16. An extendable trailer with an extending unit having a controlled release of claim 12 wherein said advance-retract means is a rack and pinion.

17. An extendable trailer with an extending unit having a controlled release of claim 16 wherein said rack and pinion is a hand operated rack and pinion.

18. An extendable trailer with an extending unit having a controlled release mechanism of claim 16 wherein said rack and pinion is a motorized rack and pinion.

19. An extendable trailer with an extending unit having a controlled release mechanism of claim 12 wherein said advance-retract means is a worm gear.

20. An extendable trailer with an extending unit having a controlled release mechanism of claim 19 wherein said worm gear is a motorized worm gear.
